(19) United States
(12) Patent Application Publication
(10) Pub. No.: US 2013/0072251 A1
(43) Pub. Date: Mar. 21, 2013

(54) MOBILE TERMINAL, METHOD FOR CONTROLLING OF THE MOBILE TERMINAL AND SYSTEM

(71) Applicants: Juhee KIM, Seoul (KR); Jungkyu CHOI, Seoul (KR); Jongse PARK, Seoul (KR); Joonyup LEE, Seoul (KR); Seokbok JANG, Seoul (KR)

(72) Inventors: Juhee KIM, Seoul (KR); Jungkyu CHOI, Seoul (KR); Jongse PARK, Seoul (KR); Joonyup LEE, Seoul (KR); Seokbok JANG, Seoul (KR)

(73) Assignee: LG ELECTRONICS INC., Seoul (KR)

(21) Appl. No.: 13/236,927

(22) Filed: Sep. 20, 2011

(51) Int. Cl. H04W 88/02

(52) U.S. Cl. 455/550.1

(57) ABSTRACT

A mobile terminal and a method and system for controlling the mobile terminal are provided. The mobile terminal performs data communication with at least one extra noise source connected to a network, and when a predetermined event occurs, the mobile terminal selects at least one of the at least one extra noise source based on a noise state of the extra noise source and controls a noise state of the selected extra noise source. Therefore, a home network environment can be more efficiently controlled using the mobile terminal.

### BACKGROUND

1. Field

The present invention relates to a mobile terminal and a method and system for controlling the mobile terminal.

2. Related Art

Nowadays, with development of hardware and software and fusion between networks, electronic devices can communicate with various methods, and a use range of the electronic devices is much enlarged.

Accordingly, it is necessary to provide a more user friendly user interface (UI) in an electronic device that can communicate with an extra electronic device, and a user requests various methods that can efficiently control the extra electronic device.

### SUMMARY

An aspect of the present invention is to provide a mobile terminal and a method and system for controlling the mobile terminal that can more efficiently control a home network environment using the mobile terminal.

The object of the present invention is not limited to the above-described objects and the other objects will be understood by those skilled in the art from the following description.

In an aspect, a mobile terminal comprises: a communication unit configured to communicate, over a network, with a noise source that generates audible noise and that is separate from the mobile terminal; and a controller configured to: detect a predetermined event; at a time related to the predetermined event, determine a noise state of the noise source that relates to audible noise generated by the noise source; and control the noise state of the noise source based on the predetermined event and the determined noise state.

Wherein the controller is configured to detect the predetermined event by detecting at least one of transmission and reception of a call at the mobile terminal.

Wherein the controller is configured to detect the predetermined event by detecting reception of a user's voice instruction.

Wherein the controller is configured to detect the predetermined event by detecting reception of a specific sound signal.

The mobile terminal further comprises a microphone, wherein the controller is configured to determine the noise state of the noise source by determining a noise intensity (dB) of the noise source based on noise inputted by the microphone.

The mobile terminal further comprises a database configured to store information related to conditions for controlling noise sources according to types of the noise sources, wherein the conditions for controlling the noise sources comprise at least one of information related to noise intensity generated by the noise sources and an operating state of the noise sources.

Wherein the controller is configured to: determine a type of the noise source; access, from the database and based on the determined type of the noise source, a condition for controlling the noise source; compare the determined noise state of the noise source with the accessed condition for controlling the noise source; based on comparison results, determine whether the determined noise state of the noise source meets the accessed condition for controlling the noise source; and reduce the noise state of the noise source based on a determination that the determined noise state of the noise source meets the accessed condition for controlling the noise source.

The mobile terminal further comprises a display unit, wherein the controller is configured to: identify multiple noise sources the controller is capable of controlling; at a time related to the predetermined event, control display, on the display unit, of a list of the multiple noise sources the controller is capable of controlling; receive user selection of at least one noise source included in the list of the multiple noise sources; and control a noise state of the at least one selected noise source.

Wherein the controller is configured to control the noise state of the noise source based on the predetermined event and the determined noise state by turning off power of the noise source.

Wherein the controller is configured to: determine a type of the predetermined event; determine a manner of controlling the noise state of the noise source based on the type of the predetermined event, the manner of controlling the noise state being different for a first type of event as compared to a second type of event; and control the noise state of the noise source in the determined manner of controlling the noise state.

Wherein the controller is configured to: monitor the predetermined event; detect termination of the predetermined event based on the monitoring; and based on the detected termination of the predetermined event, recover the noise state of the noise source to a state prior to controlling the noise state of the noise source based on the predetermined event.

Wherein the communication unit is configured to communicate with the noise source through a digital living network alliance (DLNA) network.

In another aspect, a method of controlling a mobile terminal, the method comprises: detecting a predetermined event; at a time related to the predetermined event, determining a noise state of a noise source that relates to audible noise generated by the noise source; and controlling the noise state of the noise source based on the predetermined event and the determined noise state.

The detailed matters of the embodiments will be included in the detailed description and the drawings.

### BRIEF DESCRIPTION OF THE DRAWINGS

The implementation of this document will be described in detail with reference to the following drawings in which like numerals refer to like elements.

The present invention will become more fully understood from the detailed description given herein below and the accompanying drawings, which are given by illustration only, and thus are not limitative of the present invention, and wherein:

FIG. 1 is a diagram illustrating an example of a home network environment for applying a mobile terminal according to the present invention.

FIG. 2 is a schematic diagram illustrating a system of electronic devices according to an embodiment of the present invention.

FIG. 3 is another schematic diagram illustrating the system of electronic devices according to an embodiment of the present invention.

FIG. 4 is a conceptual diagram illustrating a Digital Living Network Alliance (DLNA) network according to an embodiment of the present invention.

FIG. 5 is a block diagram illustrating functional components of the DLNA network.

FIG. 6 is a block diagram of a mobile terminal according to an embodiment of the present invention.

FIGS. 7 and 8 are perspective diagrams of the mobile terminal according to an embodiment of the present invention.

FIG. 9 is a cross-section view illustrating a proximate depth of a proximity sensor.

FIG. 10 is a flowchart illustrating a method of controlling a mobile terminal according to an embodiment of the present invention.

FIGS. 11 to 13 illustrate an illustrative event detected in a mobile terminal according to an embodiment of the present invention.

FIG. 14 is a table illustrating an example of a noise state to be controlled according to the kind of an extra noise source.

FIG. 15 is a diagram illustrating an example of automatically controlling a noise state of an extra noise source when an event occurs.

FIG. 16 is a diagram illustrating an example of manually selecting an extra noise source to be a control target.

FIG. 17 is a table illustrating an example of aligning and providing extra noise sources that can select according to a predetermined reference in order to select an extra noise source in an embodiment described with reference to FIG. 16.

FIG. 18 is a flowchart illustrating a method of controlling a mobile terminal according to another embodiment of the present invention.

FIG. 19 is a diagram illustrating a method of controlling a mobile terminal according to an embodiment described with reference to FIG. 18.

FIG. 20 is a flowchart illustrating a method of controlling a mobile terminal according to another embodiment of the present invention.

FIG. 21 is a diagram illustrating a method of controlling a mobile terminal according to an embodiment described with reference to FIG. 20.

FIG. 22 is a flowchart illustrating a method of controlling a mobile terminal according to another embodiment of the present invention.

FIG. 23 is a diagram illustrating a method of controlling a mobile terminal according to an embodiment described with reference to FIG. 22.

### DETAILED DESCRIPTION

Objectives, characteristics, and advantages of the present invention described in detail above will be more clearly understood by the following detailed description. In what follows, preferred embodiments of the present invention will be described in detail with reference to appended drawings. Throughout the document, the same reference number refers to the same element. In addition, if it is determined that specific description about a well-known function or structure related to the present invention unnecessarily brings ambiguity to the understanding of the technical principles of the present invention, the corresponding description will be omitted.

In what follows, a display device related to the present invention will be described in more detail with reference to the appended drawings. The suffix of “module” and “unit” associated with a constituting element employed for the description below does not carry a meaning or a role in itself distinguished from the other.

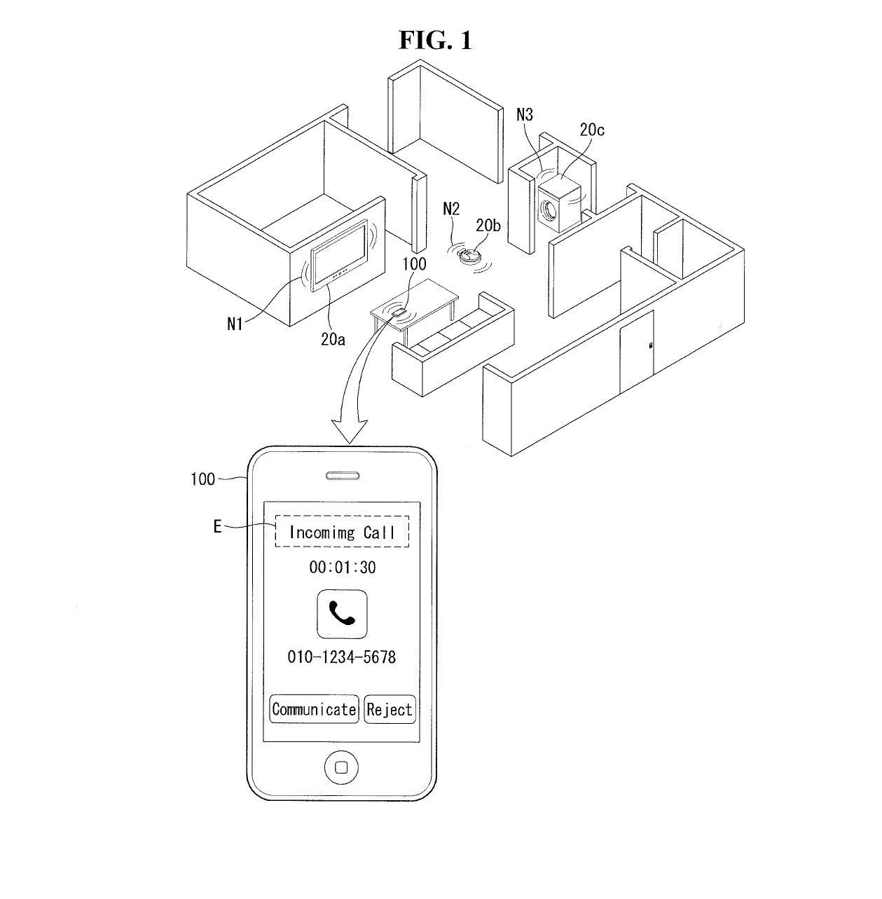

FIG. 1 is a diagram illustrating an example of a home network environment for applying a mobile terminal according to the present invention.

Referring to FIG. 1, in a home network environment for applying a mobile terminal according to the present invention, a plurality of electronic devices 20a, 20b, and 20c are connected through a predetermined network, and the home network environment includes a mobile terminal 100 that can control the plurality of electronic devices.

When a predetermined event occurs, the mobile terminal 100 according to an embodiment of the present invention controls the plurality of electronic devices 20a, 20b, and 20c on the home network by responding to the event.

The mobile terminal 100 monitors a predetermined noise state generated by the plurality of electronic devices 20a, 20b, and 20c. The mobile terminal 100 monitors the noise state at a preset cycle or receives information related to a noise state from the plurality of electronic devices 20a, 20b, and 20c when the predetermined event occurs.

As the predetermined event E occurs, for example, as a call is received and connected, the mobile terminal 100 transmits a control signal for controlling to reduce or remove noise of the peripheral plurality of electronic devices 20a, 20b, and 20c to the plurality of electronic devices 20a, 20b, and 20c.

Accordingly, the plurality of electronic devices 20a, 20b, and 20c control a noise state according to the control signal, and a user can perform smooth communication without disturbance of noise.

In this document, the plurality of electronic devices 20a, 20b, and 20c are defined as an “extra noise source” based on the mobile terminal 100 according to an embodiment of the present invention.

In order to smoothly perform an event generated in the mobile terminal 100, various sounds or vibrations generated by the plurality of electronic devices 20a, 20b, and 20c are regarded as noise.

Therefore, the mobile terminal 100 according to an embodiment of the present invention performs a method of controlling noise within a network using the mobile terminal 100 in the predetermined network (e.g., a home network) environment.

Hereinafter, a system environment for applying a mobile terminal according to the present invention will be described with reference to the drawings, and a method of controlling a mobile terminal according to an embodiment of the present invention will be described in detail with reference to the drawings.

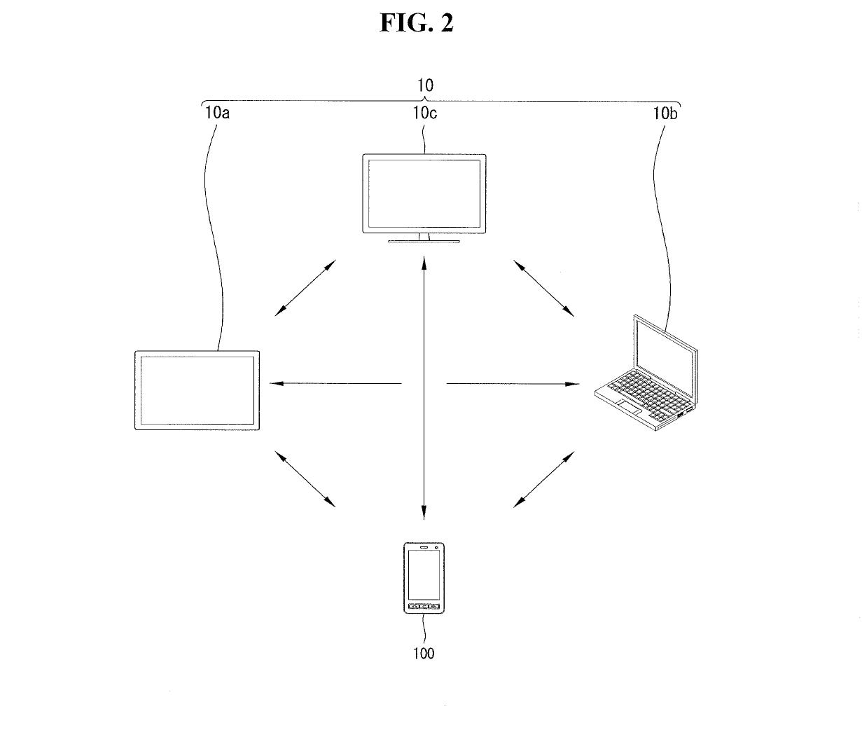

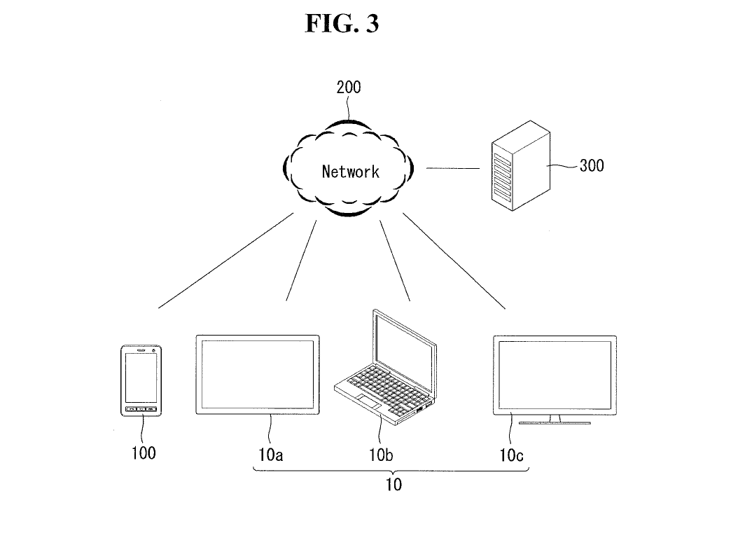

FIGS. 2 and 3 are schematic diagrams illustrating a system environment for applying a mobile terminal according to an embodiment of the present invention.

FIG. 2 is a schematic diagram illustrating a system of electronic devices according to an embodiment of the present disclosure. FIG. 3 is another schematic diagram illustrating the system of electronic devices according to an embodiment of the present disclosure.

Referring to FIGS. 2 and 3, a system environment 600 includes the mobile terminal 100, a plurality of external electronic devices 10, a network 200, and a server 300 connected to the network 200.

Referring to FIG. 2, the mobile terminal 100 and the plurality of external electronic devices 10 can each communicate with the network 200. For example, the mobile terminal 100 and the plurality of external electronic devices 10 can receive multimedia content from the server 300.

The network 200 may include at least a mobile communications network, wired or wireless Internet, or a broadcast network.

The plurality of external electronic devices 10 may include at least stationary or mobile terminals. For example, the plurality of external electronic devices 10 may include handheld phones, smart phones, computers, laptop computers, personal digital assistants (PDAs), portable multimedia players (PMPs), personal navigation devices, or mobile Internet devices (MIDs).

Referring to FIG. 2, the plurality of external electronic devices 100 and 10 may communicate with each other by wireless or wired communication. The mobile terminal 100 can be a handheld phone or mobile phone. The plurality of external electronic devices 10 may include at least a first external electronic device 10a (e.g., a mobile terminal), a second external electronic device 10b (e.g., a computer), or a third external electronic device 10c (e.g., a television).

The method of communication between the mobile terminal 100 and the plurality of external electronic devices 10 is not limited. Existing and future methods of wireless communications between electronic devices are applicable.

For example, the mobile terminal 100 and the plurality of external electronic devices 10 can communicate with each other by a communication methods, such as Universal Plug and Play (UPnP), Digital Living Network Alliance (DLNA), or Wireless Fidelity (WiFi). Moreover, the mobile terminal 100 and the plurality of external electronic devices 10 can communicate with each other via the network 200 or a short-range communication method.

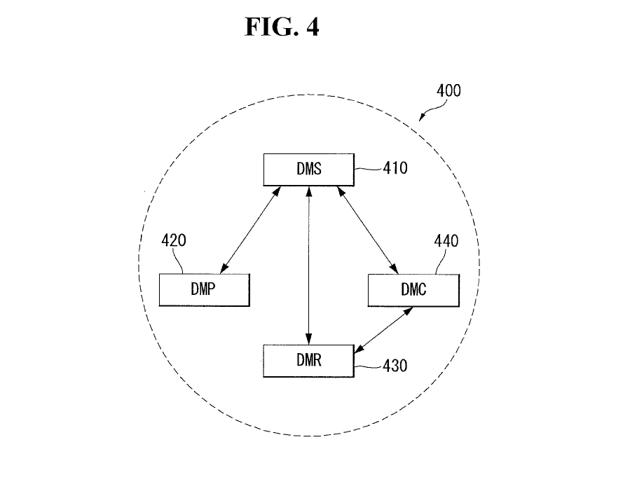

FIG. 4 is a conceptual diagram illustrating a Digital Living Network Alliance (DLNA) network according to an embodiment of the present disclosure. The DLNA is an organization that creates standards for sharing content, such as music, video, or still images between electronic devices over a network. The DLNA is based on the Universal Plug and Play (UPnP) protocol.

The DLNA network 400 may comprise a digital media server (DMS) 410, a digital media player (DMP) 420, a digital media render (DMR) 430, and a digital media controller (DMC) 440.

The DLNA network 400 may include at least the DMS 410, DMP 420, DMR 430, or DMC 440. The DLNA may provide a standard for compatibility between each of the devices. Moreover, the DLNA network 400 may provide a standard for compatibility between the DMS 410, the DMP 420, the DMR 430, and the DMC 440.

The DMS 410 can provide digital media content. That is, the DMS 410 is able to store and manage the digital media content. The DMS 410 can receive various commands from the DMC 440 and perform the received commands. For example, upon receiving a play command, the DMS 410 can search for content to be played back and provide the content to the DMR 430. The DMS 410 may comprise a personal computer (PC), a personal video recorder (PVR), and a set-top box, for example.

The DMP 420 can control either content or electronic devices, and can play back the content. That is, the DMP 420 is able to perform the function of the DMR 430 for content playback and the function of the DMC 440 for control of other electronic devices. The DMP 420 may comprise a television (TV), a digital TV (DTV), and a home sound theater, for example.

The DMR 430 can play back the content received from the DMS 410. The DMR 430 may comprise a digital photo frame.

The DMC 440 may provide a control function for controlling the DMS 410, the DMP 420, and the DMR 430. The DMC 440 may comprise a handheld phone and a PDA, for example.

In some embodiments, the DLNA network 400 may comprise the DMS 410, the DMR 430, and the DMC 440. In other embodiments, the DLNA network 400 may comprise the DMP 420 and the DMR 430.

In addition, the DMS 410, the DMP 420, the DMR 430, and the DMC 440 may serve to functionally discriminate the electronic devices from each other. For example, if a handheld phone has a playback function as well as a control function, the handheld phone may be the DMP 420. Alternatively, the DTV may be configured to manage content and, therefore, the DTV may serve as the DMS 410 as well as the DMP 420.

In some embodiments, the mobile terminal 100 and the plurality of external electronic devices 10 may constitute the DLNA network 400 while performing the function corresponding to at least the DMS 410, the DMP 420, the DMR 430, or the DMC 440.

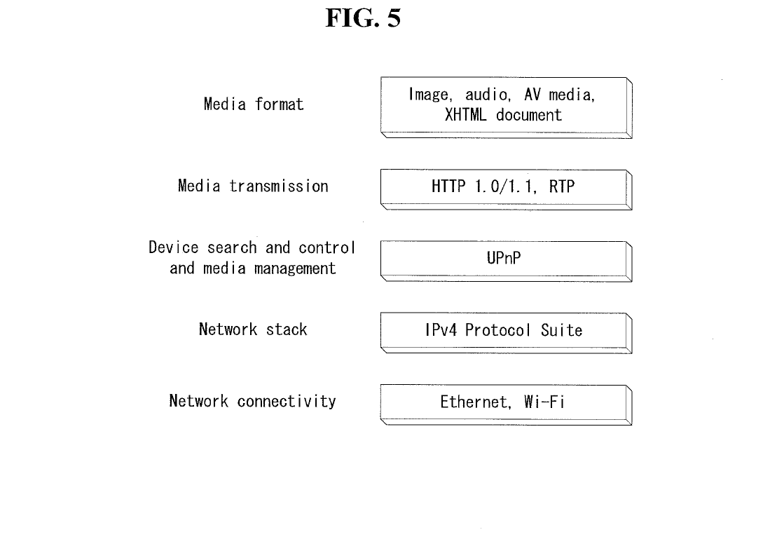

FIG. 5 is a block diagram illustrating functional components of the DLNA network. The functional components of the DLNA may comprise a media format layer, a media transport layer, a device discovery & control and media management layer, a network stack layer, and a network connectivity layer.

The media format layer may use images, audio, audio-video (AV) media, and Extensible Hypertext Markup Language (XHTML) documents.

The media transport layer may use a Hypertext Transfer Protocol (HTTP) 1.0/1.1 networking protocol for streaming playback over a network. Alternatively, the media transport layer may use a real-time transport protocol (RTP) networking protocol.

The device discovery & control and media management layer may be directed to UPnP AV Architecture or UPnP Device Architecture. For example, a simple service discovery protocol (SSDP) may be used for device discovery on the network. Moreover, a simple object access protocol (SOAP) may be used for control.

The network stack layer may use an Internet Protocol version 4 (IPv4) networking protocol. Alternatively, the network stack layer may use an IPv6 networking protocol.

The network connectivity layer may comprise a physical layer and a link layer of the network. The network connectivity layer may further include at least Ethernet, WiFi, or Bluetooth®. Moreover, a communication medium capable of providing an IP connection may be used.

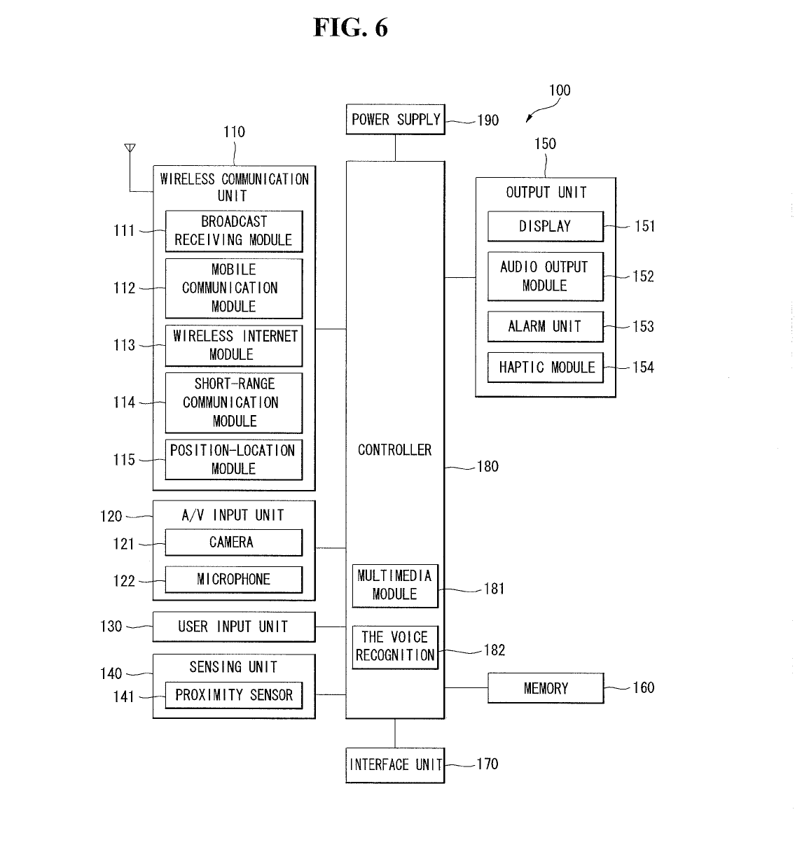

FIG. 6 is a block diagram of a mobile terminal 100 according to an embodiment of the present disclosure. The mobile terminal 100 may refer to an electronic device among a plurality of external electronic devices on a network according to an embodiment of the present disclosure, which will be described in more detail with reference to the drawings.

Referring to FIG. 6, the mobile terminal 100 includes a wireless communication unit 110, an A/V (audio/video) input unit 120, a user input unit 130, a sensing unit 140, an output unit 150, a memory 160, an interface unit 170, a controller 180, and a power supply unit 190. FIG. 6 shows the mobile terminal 100 having various components, but it is understood that implementing all of the illustrated components is not required. Greater or fewer components may alternatively be implemented.

The wireless communication unit 110 can include one or more components that permit wireless communication between the mobile terminal 100 and a wireless communication system or network within which the mobile terminal 100 is located. For example, the wireless communication unit 110 can include a broadcast receiving module 111, a mobile communication module 112, a wireless Internet module 113, a short-range communication module 114, and a position-location module 115.

The broadcast receiving module 111 receives a broadcast signal and/or broadcast associated information from an external broadcast managing server (not shown) via a broadcast channel. The broadcast channel may include a satellite channel and a terrestrial channel.

The broadcast managing server generally refers to a server which generates and transmits the generated broadcast signal and/or broadcast associated information or a server which is provided with a previously generated broadcast signal and/or broadcast associated information and then transmits the provided broadcast signal or information to the mobile terminal 100. The transmitted broadcast signal may be implemented as a television (TV) broadcast signal, a radio broadcast signal, and a data broadcast signal. The transmitted broadcast signal may be combined with a TV or radio broadcast signal.

The broadcast associated information can include information associated with a broadcast channel, a broadcast program, and a broadcast service provider. The broadcast associated information can be provided via a mobile communication network, and be received by the mobile communication module 112 via a broadcast signal antenna 116.

The broadcast associated information can be implemented in various forms. For example, broadcast associated information may include an electronic program guide (EPG) related to digital multimedia broadcasting (DMB) and electronic service guide (ESG) related to digital video broadcast-handheld (DVB-H).

The broadcast receiving module 111 may be configured to receive broadcast signals transmitted from various types of broadcasting systems. The broadcasting systems can include digital multimedia broadcasting-terrestrial (DMB-T), digital multimedia broadcasting-satellite (DMB-S), digital video broadcast-handheld (DVB-H), media forward link only (MediaFLO®) and integrated services digital broadcast-terrestrial (ISDB-T). Greater or fewer broadcasting systems can be received by the broadcast receiving module 111.

The broadcast signal and/or broadcast associated information received by the broadcast receiving module 111 may be stored in a storage device, such as the memory 160.

The mobile communication module 112 transmits and receives wireless signals between one or more network entities (e.g., base station, external terminal, and server) via the broadcast signal antenna 116. The transmitted and received wireless signals may represent audio, video, and data signals according to text or multimedia message transmissions.

The wireless Internet module 113 supports Internet access for the mobile terminal 100. The wireless Internet module 113 may be internally or externally coupled to the mobile terminal 100. In this case, the wireless Internet technology supported by the wireless Internet module 113 can include Wireless LAN (WLAN), Wireless Fidelity (Wi-Fi™) Wibro (Wireless broadband), World Interoperability for Microwave Access (WiMAX), and High Speed Downlink Packet Access (HSDPA).

The short-range communication module 114 facilitates relatively short-range communications. Suitable technologies for implementing the short-range communication module 114 can include radio frequency identification (RFID), infrared data association (IrDA), ultra-wideband (UWB), Bluetooth® and ZigBee®.

The position information module 115 is a module for identifying or otherwise obtaining a position of the mobile terminal. The position information module 115 can acquire position information using a global navigation satellite system (GNSS). Here, GNSS refers to radio navigation satellite systems that orbit the earth and transmit reference signals so that the location of certain types of radio navigation receivers on the earth's surface can be determined or approximated. GNSS includes a global positioning system (GPS) managed by the USA, Galileo managed by Europe, global orbiting navigational satellite system (GLONASS) managed by Russia, COMPASS managed by China, and quasi-zenith satellite system (QZSS) managed by Japan.

As one representative example of GNSS, the position information module 115 may be a GPS (Global Positioning System) module. The GPS module 115 can calculate information on distances between one point (object) and at least three satellites, information on the time when the distance information is measured, and use the obtained distance information to triangulate three-dimensional position information on the point (object) according to latitude, longitude and altitude at a predetermined time. Moreover, a method of calculating position and time information using three satellites and correcting the calculated position and time information using another satellite can also be used. In addition, the GPS module 115 continuously calculates the current position in real time and calculates velocity information using the position information.

The audio/video (A/V) input unit 120 can be configured to provide audio or video signal input to the mobile terminal 100. The A/V input unit 120 can include a camera 121, a microphone 122, a flash module 123 and a mirror module 124. The camera 121 can receive and process image frames of still pictures (e.g., photographs) obtained by an image sensor when the mobile terminal 100 is in a photographing mode, and alternatively, receive and process moving picture data (e.g., video) when the mobile terminal 100 is in a video call mode. The processed image frames can be displayed by the output unit 150, such as a display 151.

The image frames processed by the camera 121 can be stored in the memory 160 or can be externally transmitted via the wireless communication unit 110. At least two cameras 121 can be provided in the mobile terminal 100 depending on the usage environment.

The microphone 122 receives an external audio signal while the mobile terminal 100 is in a particular mode, such as a phone call mode, a recording mode and a voice recognition mode. The external audio signal is processed and converted into digital audio data. The digital audio data is transformed into a format transmittable to a mobile communication base station via the mobile communication module 112 when the mobile terminal 100 is in a call mode. The microphone 122 can include assorted noise removing algorithms to remove noise generated when receiving the external audio signal.

The microphone 122 of the mobile terminal 100 according to an embodiment of the present invention collects a sound signal output from the extra noise sources (20a, 20b, and 20c of FIG. 1) or vibration noise generated by a physical vibration of the extra noise source in addition to noise generated in a process of receiving the external sound signal.

The extra noise sources (20a, 20b, and 20c of FIG. 1) correspond to extra electronic devices, as in reference numbers 10a, 10b, and 10c of FIGS. 2 and 3.

The flash module 123 can provide lighting in conjunction with the camera 121 obtaining images of the external environment. The mirror module 124 can provide a user with a reflective surface.

The user input unit 130 generates input data responsive to user manipulation of one or more associated input devices. Examples of such input devices can include a keypad, a dome switch, a touchpad (e.g., static pressure/capacitance), a jog wheel, and a jog switch.

The sensing unit 140 provides sensing signals for controlling operations of the mobile terminal 100 using status measurements of various aspects of the mobile terminal 100. For example, the sensing unit 140 may detect an open/close status of the mobile terminal 100, a relative positioning of components (e.g., a display and keypad) of the mobile terminal 100, a change of position of the mobile terminal 100 or a component of the mobile terminal 100, a presence or absence of user contact with the mobile terminal 100, or an orientation or acceleration/deceleration of the mobile terminal 100.

In another example, when the mobile terminal 100 is configured as a slide-type mobile terminal, the sensing unit 140 may sense whether a sliding portion of the mobile terminal 100 is open or closed. In another example, the sensing unit 140 can sense the presence or absence of power provided by the power supply unit 190, the presence or absence of a coupling or connection between the interface unit 170 and a device external to the mobile terminal 100. The sensing unit 140 can include a proximity sensor 141.

The output unit 150 generates outputs relevant to senses of sight, hearing, and touch. The output unit 150 can include the display 151, an audio output module 152, an alarm 153, a haptic module 154 and an earphone module 156.

The display 151 can be implemented to visually display or output information associated with the mobile terminal 100. For example, if the mobile terminal 100 is operating in a phone call mode, the display 151 can provide a user interface (UI) or graphical user interface (GUI) which includes information associated with placing, conducting, and terminating a phone call. In another example, if the mobile terminal 100 is in a video call mode or a photographing mode, the display 151 may additionally or alternatively display images which are associated with the photographing or video call modes, the UI or the GUI.

The display 151 may be implemented using one or more display technologies which include a liquid crystal display (LCD), a thin film transistor-liquid crystal display (TFT-LCD), an organic light-emitting diode display (OLED), a flexible display and a three-dimensional (3D) display. Moreover, a transparent display can be implemented using some of the foregoing display technologies in a transparent or optical transmissive type, such as a transparent OLED (TOLED).

A rear configuration of the display 151 can be implemented in the optical transmissive type as well. In this configuration, a user can see an object at a rear portion of the mobile terminal 100 via an area occupied by the display 151.

At least two display modules 151 can be provided in the mobile terminal 100. For example, a plurality of display modules 151 can be arranged on a single face of the mobile terminal 100 spaced apart from each other or built into one body. Alternatively, a plurality of display modules 151 can be arranged on different faces of the mobile terminal 100.

If the display 151 and the sensing unit 140 for detecting a touch action (hereinafter called “touch sensor”) are configured as a mutual layer structure (hereinafter called “touch screen”), the display 151 can be used as a user input unit 130 as well as an output unit 150. The touch sensor can be configured as a touch film, a touch sheet, or a touchpad.

The touch sensor can be configured to convert a pressure applied to a specific portion of the display 151 or a variation of a capacitance generated from a specific portion of the display 151 to an electric input signal. Accordingly, the touch sensor detects a pressure of a touch as well as a touched position or size.

If a touch input is made to the touch sensor, signal(s) corresponding to the touch input is transferred to a touch controller (not shown). The touch controller processes the signal(s) and then transfers the processed signal(s) to the controller 180. Therefore, the controller 180 can determine whether a prescribed portion of the display 151 has been touched.

The proximity sensor 141 can be provided to an internal area of the mobile terminal 100 enclosed by the display 151, such as the touch screen or around the touch screen. The proximity sensor 141 is a sensor that detects a presence of an object approaching a prescribed detecting surface or an object existing around the proximity sensor 141 using an electromagnetic field strength or infrared ray without mechanical contact. The proximity sensor 141 can be more durable and more useful than a contact type sensor.

The proximity sensor 141 can include a transmissive photoelectric sensor, a direct reflective photoelectric sensor, a mirror reflective photoelectric sensor, a radio frequency oscillation proximity sensor, an electrostatic capacity proximity sensor, a magnetic proximity sensor, or an infrared proximity sensor. If the touch screen includes the electrostatic capacity proximity sensor, the touch screen is configured to detect the proximity of a pointer according to a variation in an electric field formed by the proximity of the pointer to the touch screen. Accordingly, the touch screen or touch sensor can be classified as the proximity sensor 141.

An action when a pointer approaches without contacting the touch screen so the pointer is recognized as being located on the touch screen is defined as “proximity touch.” An action when a pointer actually touches the touch screen is defined as “contact touch.” The meaning of the position on the touch screen proximity-touched by the pointer means the position of the pointer which vertically opposes the touch screen when the pointer performs the proximity touch.

The proximity sensor 141 detects a proximity touch and a proximity touch pattern (e.g., a proximity touch distance, a proximity touch duration, a proximity touch position, or a proximity touch shift state.). Information corresponding to the detected proximity touch action and the detected proximity touch pattern can be displayed on the touch screen.

The audio output module 152 functions in various modes including a call-receiving mode, a call-placing mode, a recording mode, a voice recognition mode, and a broadcast reception mode in order to output audio data which is received from the wireless communication unit 110 or stored in the memory 160. During operation, the audio output module 152 outputs audio relating to a particular function (e.g., call received, message received). The audio output module 152 can be implemented individually or by using one or more speakers, buzzers, and other audio producing devices.

The alarm 153 outputs a signal for announcing an occurrence of a particular event associated with the mobile terminal 100. Examples of the announced events can include a call received event, a message received event, a touch input received event, a voice input of a speaker, a gesture input, a message input, various control inputs through a remote controller, transmission and reception of a call, and an input a specific sound signal.

The alarm 153 can output a signal for announcing the event occurrence by way of vibration as well as via a video or audio signal. The video or audio signal can be output via the display 151 or the audio output module 152. Hence, the display 151 or the audio output module 152 can be regarded as a part of the alarm 153.

The haptic module 154 generates various tactile effects that can be sensed by a user. Vibration is a representative tactile effect generated by the haptic module 154. Strength and pattern of the vibration generated by the haptic module 154 can be controlled. For example, different vibrations can be output simultaneously or sequentially.

The haptic module 154 can generate various tactile effects as well as the vibration. For example, the haptic module 154 generates an effect attributed to the arrangement of pins vertically moving against a contact skin surface, an effect attributed to the injection/suction power of air though an injection/suction hole, an effect attributed to skimming over a skin surface, an effect attributed to the contact with an electrode, an effect attributed to electrostatic force, or an effect attributed to the representation of hold/cold sense using an endothermic or exothermic device.

The haptic module 154 can be implemented to enable a user to sense the tactile effect through a muscle sense of a finger or an arm as well as to transfer the tactile effect through direct contact. At least two haptic modules 154 can be provided in the mobile terminal 100.

Furthermore, the audio output module 152 can output sound through an earphone jack 156. The user can connect earphones to the earphone jack 156 and hear the output sound.

When an event requiring the control of a noise state of the extra noise source 20a, 20b, and 20c is received, the haptic module 154 of the mobile terminal 154 according to an embodiment of the present invention transfers a vibration of a specific vibration pattern to a user, thereby guiding the user to enter a mode that can control a noise state of the extra noise sources 20a, 20b, and 20c.

The memory 160 can be used to store various types of data to support processing, control, and storage requirements of the mobile terminal 100. Examples of such stored data include program instructions for applications operating on the mobile terminal 100, contact data, phonebook data, messages, audio, still pictures, and moving pictures. The memory 160 can also store a recent use history or a cumulative use frequency of each data (e.g., use frequency for each phonebook, each message or each multimedia). Moreover, data for various patterns of vibration and/or sound output can be stored in the memory 160 when a touch input to the touch screen is sensed.

The mobile terminal is connected to the network and thus the memory 160 stores information related to a noise control target and a noise control condition. The noise control target includes the extra noise source (20a, 20b, and 20c of FIG. 1), and the noise control condition may be a condition about whether a noise state of the extra noise source (20a, 20b, and 20c of FIG. 1) corresponds to a predetermined reference.

Furthermore, the memory 160 may include an audio model, a recognition dictionary, a translation database, a predetermined language model, and a command database which are necessary for the operation of the present invention.

The recognition dictionary can include at least one form of a word, a clause, a keyword, and an expression of a particular language.

The translation database can include data matching multiple languages to one another. For example, the translation database can include data matching a first language (Korean) and a second language (English/Japanese/Chinese) to each other. The second language is a terminology introduced to distinguish from the first language and can correspond to multiple languages. For example, the translation database can include data matching [symbol] in Korean to “I'd like to make a reservation” in English.

The command databases form a set of commands capable of controlling the electronic device 100. The command databases may exist in independent spaces according to content to be controlled. For example, the command databases may include a channel-related command database for controlling a broadcasting program, a map-related to command database for controlling a navigation program, a game-related command database for controlling a game program.

Each of one or more commands included in each of the channel-related command database, the map-related command database, and the game-related command database has a different subject of control.

For example, in “Channel Switch Command” belonging to the channel-related command database, a broadcasting program is the subject of control. In a “Command for Searching for the Path of the Shortest Distance” belonging to the map-related command database, a navigation program is the subject of control.

Kinds of the command databases are not limited to the above example, and they may exist according to the number of pieces of content which may be executed in the electronic device 100.

Meanwhile, the command databases may include a common command database. The common command database is not a set of commands for controlling a function unique to specific content being executed in the electronic device 100, but a set of commands which can be in common applied to a plurality of pieces of content.

For example, assuming that two pieces of content being executed in the electronic device 100 are game content and a broadcasting program, a voice command spoken in order to raise the volume during play of the game content may be the same as a voice command spoken in order to raise the volume while the broadcasting program is executed.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory), or other similar memory or data storage device. Further, the mobile terminal 100 can operate via a web storage entity for performing a storage function of the memory 160 on the Internet.

The interface unit 170 can be implemented to couple the mobile terminal 100 with external devices. The interface unit 170 receives data from the external devices or is supplied with power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, and an earphone port.

The identity module (not shown) can be an integrated circuit for storing various types of information for authenticating a use authority of the mobile terminal 100 and can include a User Identify Module (UIM), Subscriber Identify Module (SIM), and Universal Subscriber Identity Module (USIM). A device having the identity module (hereinafter called “identity device”) can be manufactured as a smart card. Therefore, the identity device can be connected to the mobile terminal 100 via a corresponding port.

When the mobile terminal 100 is connected to an external cradle, the interface unit 170 provides a passage for supplying power to the mobile terminal 100 from the external cradle or a passage for delivering various command signals input by a user via the external cradle, to the mobile terminal 100. Each of the delivered command signals input via the external cradle or the supplied power can signal that the mobile terminal 100 has been correctly loaded in the external cradle.

The controller 180 controls the overall operations of the mobile terminal 100. For example, the controller 180 controls and processes voice calls, data communications, and video calls.

The controller 180 may include a multimedia module 181 that provides multimedia playback. The multimedia module 181 may be configured as part of the controller 180, or implemented as a separate component. Moreover, the controller 180 can perform a pattern recognition process for recognizing characters of a written input and images of a picture drawing input carried out on the touch screen.

The controller 10 can further comprise a voice recognition unit 182 carrying out voice recognition upon the voice of at least one speaker and although not shown, a voice synthesis unit (not shown), a sound source detection unit (not shown), and a range measurement unit (not shown) which measures the distance to a sound source.

The voice recognition unit 182 can carry out voice recognition upon voice signals input through the microphone 122 of the electronic device 100 or the remote control 10 and/or the mobile terminal shown in FIG. 6; the voice recognition unit 182 can then obtain at least one recognition candidate corresponding to the recognized voice. For example, the voice recognition unit 182 can recognize the input voice signals by detecting voice activity from the input voice signals, carrying out sound analysis thereof, and recognizing the analysis result as a recognition unit. And the voice recognition unit 182 can obtain the at least one recognition candidate corresponding to the voice recognition result with reference to the recognition dictionary and the translation database stored in the memory 160.

The voice synthesis unit (not shown) converts text to voice by using a TTS (Text-To-Speech) engine. TTS technology converts character information or symbols into human speech. TTS technology constructs a pronunciation database for each and every phoneme of a language and generates continuous speech by connecting the phonemes. At this time, by adjusting magnitude, length, and tone of the speech, a natural voice is synthesized; to this end, natural language processing technology can be employed. TTS technology can be easily found in the electronics and telecommunication devices such as CTI, PC, PDA, and mobile devices; and consumer electronics devices such as recorders, toys, and game devices. TTS technology is also widely used for factories to improve productivity or for home automation systems to support much comfortable living. Since TTS technology is one of well-known technologies, further description thereof will not be provided.

The power supply unit 190 provides power required by the various components of the mobile terminal 100. The provided power may be provided internally or externally to the mobile terminal 100.

Various embodiments described herein may be implemented in a computer-readable medium using, for example, computer software, hardware, or some combination thereof. For a hardware implementation, the embodiments described herein may be implemented individually or combined within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or other electronic units designed to perform the functions described herein. The foregoing embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

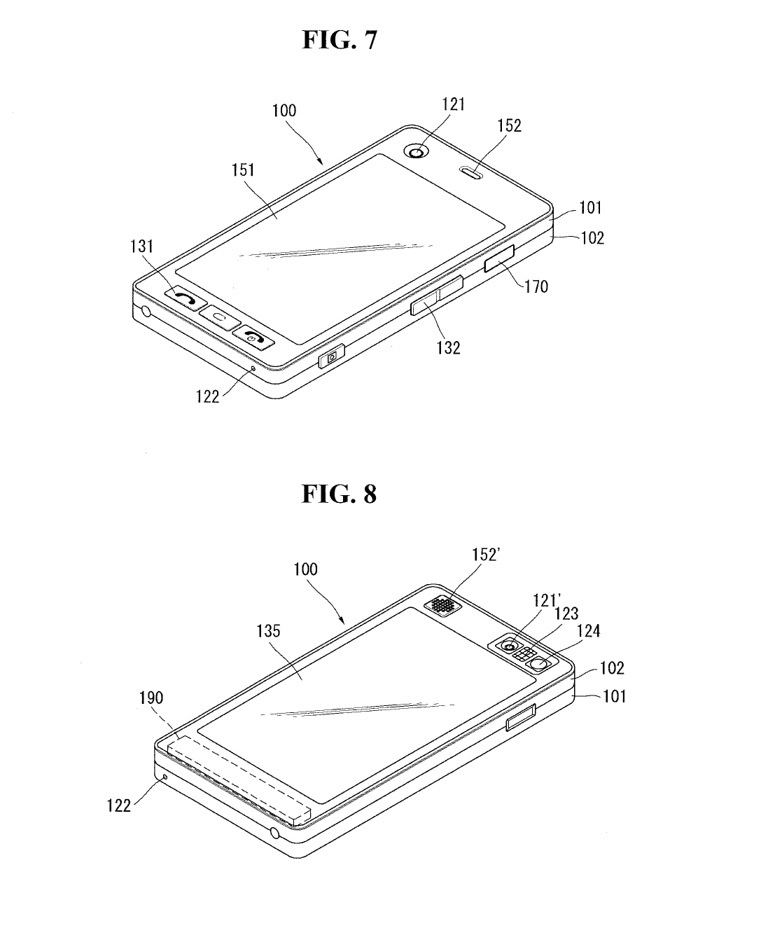

FIG. 7A is a perspective diagram of a front side of the mobile terminal 100 according to an embodiment of the present disclosure. The mobile terminal 100 is configured to have a bar-type terminal body. Yet, the mobile terminal 100 may be implemented in a variety of different configurations. Examples of such configurations include a folder-type, a slide-type, a rotational-type, a swing-type and combinations thereof. For clarity, the remainder of the disclosure will discuss the mobile terminal 100 directed to the bar-type terminal body. However such teachings apply equally to other types of mobile terminals.

Referring to FIG. 7A, the mobile terminal 100 includes a case (casing, housing, cover, etc.) configuring an exterior thereof. In the present embodiment, the case can be divided into a front case 101 and a rear case 102. Various electric or electronic parts are loaded in a space provided between the front case 101 and rear case 102. Optionally, at least one middle case can be additionally provided between the front case 101 and rear case 102.

The cases 101 and 102 can be formed by injection molding of synthetic resin or can be formed of metal substances such as stainless steel or titanium.

The front case 101 of the mobile terminal 100 can include at least the display 151, the audio output unit 152, a camera 121, user input units 131 and 132, the microphone 122, or the interface unit 170.

The display 151 occupies most of a main face of the front case 101. The audio output unit 151 and the camera 121 are provided on an area adjacent to one of two end portions of the display 151, while the user input unit 131 and the microphone 122 are provided to another area adjacent to the other end portion of the display 151. The user input unit 132 and the interface unit 170 can be provided on lateral sides of the front case 101 and rear case 102.

The input unit 130 is manipulated to receive a command for controlling an operation of the mobile terminal 100. The input unit 130 is able to include a plurality of manipulating units 131 and 132. The manipulating units 131 and 132 can be named a manipulating portion and may adopt any mechanism of a tactile manner that enables a user to perform a manipulation action by sensing a tactile feedback.

Content input by the first manipulating unit 131 or second manipulating unit 132 can be diversely set. For instance, commands such as start, end or scroll can be input to the first manipulating unit 131. On the other hand, commands directed to adjusting a volume of sound outputting from the audio output unit 152 or switching to a touch recognizing mode of the display 151 can be input to the second manipulating unit 132.

FIG. 7B is a perspective diagram of a backside of the mobile terminal 100 shown in FIG. 6A. Referring to FIG. 6B, a camera 121′ can be additionally provided to a backside of the mobile terminal 100, and more particularly, to the rear case 102. The camera 121′ has a photographing direction that is substantially opposite to that of the camera 121 shown in FIG. 6A and may have a different number of pixels to provide a different resolution from that of the camera 121.

Preferably the camera 121 can have enough resolution to capture and transmit a picture of a user's face for a video call, while the camera 121′ has a higher resolution for capturing a general subject for photography without transmitting the captured subject. Each of the cameras 121 and 121′ can be installed in the mobile terminal 100 to be rotated open or popped open.

The flash module 123 and the mirror module 124 are additionally provided adjacent to the camera 121′. The flash module 123 projects light toward a subject in case of photographing the subject using the camera 121′. In case that a user attempts to take a picture of the user (e.g., self-photography) using the camera 121′, the mirror module 124 enables the user to view user's face reflected by the mirror module 124.

An additional audio output unit 152′ can be provided to the backside of the mobile terminal 100. The additional audio output unit 152′ is able to implement a stereo function together with the audio output unit 152 shown in FIG. 6A and may be used to implement a speakerphone mode when the mobile terminal 100 is configured in the phone call mode.

The broadcast signal antenna 116 can be provided to the lateral side of the mobile terminal 100 to provide further communication capabilities to the mobile terminal 100. The broadcast signal antenna 116 can be constructed as a portion of the broadcast receiving module 111 shown in FIG. 6B. Additionally, the broadcast signal antenna 116 can be configured to be retractable in the mobile terminal 100.

The power supply unit 190 for supplying power to the mobile terminal 100 can be configured to be built within the mobile terminal 100. Alternatively, the power supply unit 190 can be configured to be detachably connected to the mobile terminal 100.

A touchpad 135 for detecting a touch can be additionally provided to the rear case 102. The touchpad 135 can be configured in a light transmissive type like the display 151. In this case, if the display 151 is configured to output visual information from its both faces, it is able to recognize the visual information via the touchpad 135 as well. The information output from both of the faces can be entirely controlled by the touchpad 135. Alternatively, a display is further provided to the touchpad 135 so that a touch screen can be provided to the rear case 102 as well.

The touchpad 135 is activated by interconnecting with the display 151 of the front case 101. The touchpad 135 can be provided in rear of the display 151 in parallel. The touchpad 135 can have a size equal to or smaller than that of the display 151.

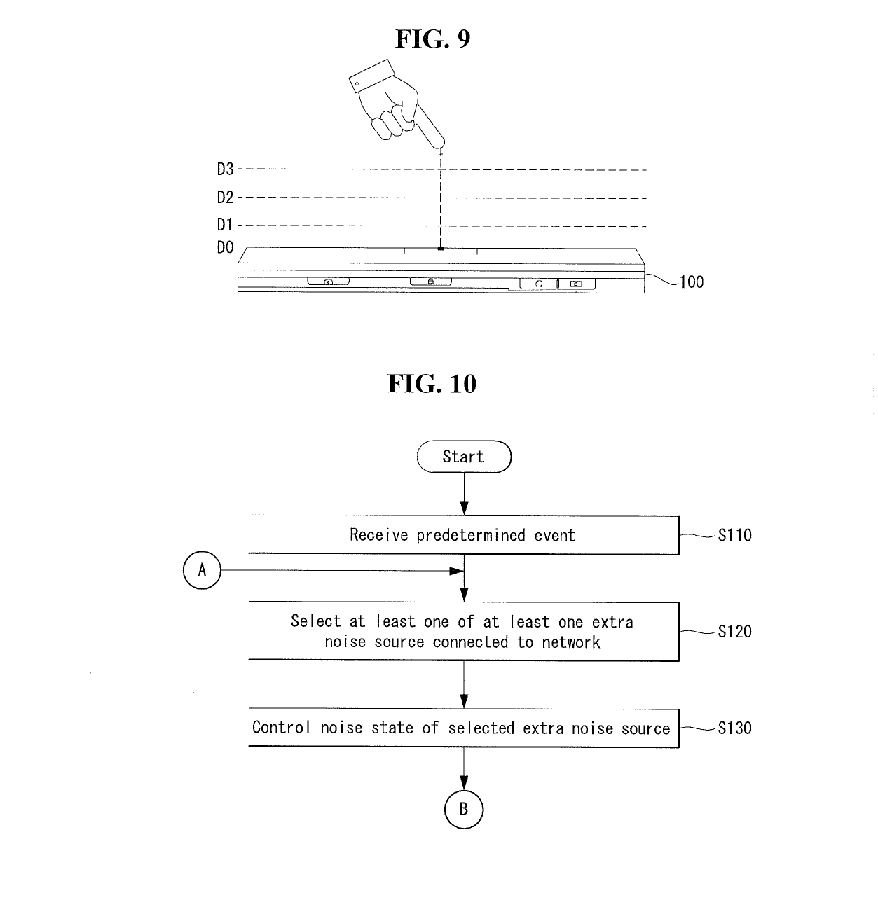

FIG. 9 is a cross-section diagram for explaining a proximity depth of a proximity sensor 141 (FIG. 6) according to an embodiment of the present disclosure. When a pointer, such as a user's finger or a pen approaches the display 151, the proximity sensor 141 provided within or in the vicinity of the display 151 detects the approach of the pointer and then outputs a proximity signal. The proximity sensor 141 can be configured to output a different proximity signal according to a distance between the pointer and the proximity-touched display 151 (hereinafter “proximity depth”).

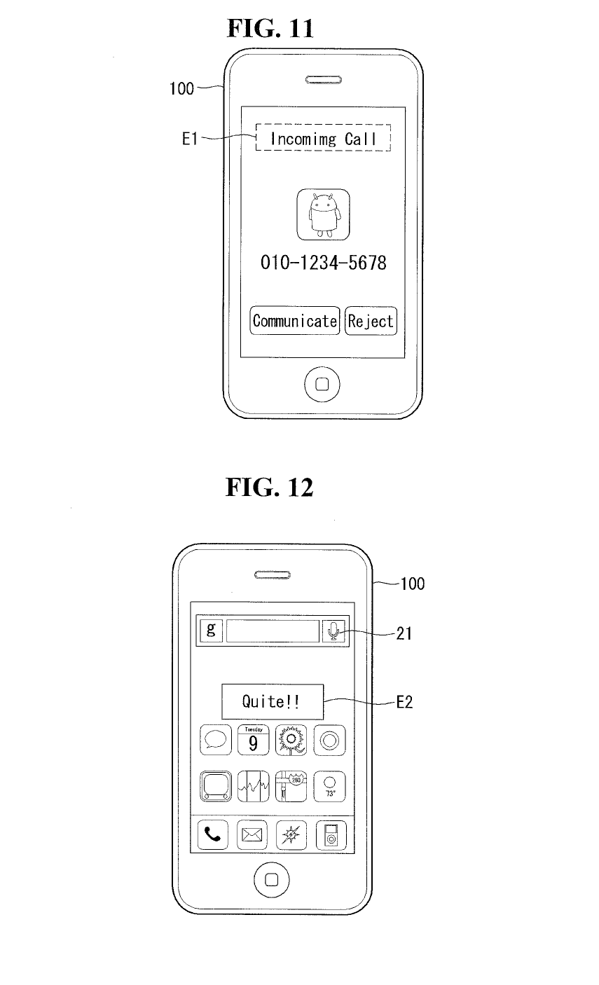

Referring to FIG. 10, a cross-section of the mobile terminal 100 is provided with the proximity sensor 141 capable of sensing three proximity depths, for example. It can be understood that the proximity sensor 141 can be capable of sensing proximity depths amounting to a number smaller than 3 and equal to or greater than 4.

For example, when the pointer is fully contacted with the display 151 at d0, the relation is recognized as a contact touch. When the pointer is spaced apart from the display 151 at a distance d1, the relation is recognized as a proximity touch at a first proximity depth. When the pointer is spaced apart from the display 151 at a distance between d1 and d2, the relation is recognized as a proximity touch at a second proximity depth. When the pointer is spaced apart from the display 151 at a distance between d2 and d3, the relation is recognized as a proximity touch at a third proximity depth. Further, when the pointer is spaced apart from the display 151 at a distance equal to or greater than d3, no proximity touch is recognized.

Hence, the controller 180 can recognize the proximity touch as one of various input signals according to the proximity depth and position of the pointer relative to the display 151. In some examples, the controller 180 can perform various operation controls according to the various input signals.

The mobile terminal 100 described with reference to FIGS. 5 to 8 is an example disclosed according to the sprit of the present invention. A plurality of electronic devices 20a, 20b, and 20c disclosed according to the sprit of the present invention may omit some of constituent elements of the mobile terminal 100, or may include a constituent element that is not included in the mobile terminal 100.

Hereinafter, embodiments of the present invention will be described. In the present invention, for convenience of description, it is assumed that the display 151 of the mobile terminal 100 is a touch screen. As described above, the touch screen can perform both an information display function and an information input function. However, the present invention is not limited thereto. Further, a touch described in this document includes both a contact touch and a proximity touch.

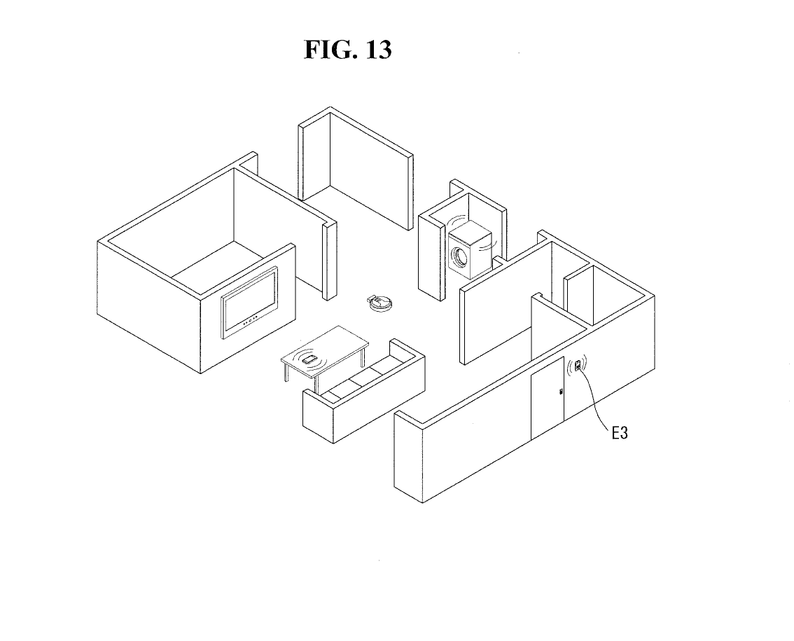

FIG. 10 is a flowchart illustrating a method of controlling a mobile terminal according to an embodiment of the present invention, and FIGS. 11 to 13 illustrate an illustrative event detected in a mobile terminal according to an embodiment of the present invention.

Hereinafter, a method of controlling a mobile terminal according to an embodiment of the present invention will be described with reference to the drawings.

Referring to FIG. 10, the mobile terminal 100 receives a predetermined event (S110).

The predetermined event is an event that guides the mobile terminal 100 to control a noise state of peripheral plurality of extra noise sources.

The predetermined event may include at least one of transmission and reception of a call, reception of a user's voice instruction, and reception of a specific sound signal.

For example, when the mobile terminal 100 receives a call, the controller 180 of the mobile terminal 100 may intercept various noises generated by the extra noise sources (20a, 20b, and 20c of FIG. 1) connected to a network.

Referring to FIG. 11, the mobile terminal 100 receives a call that can control a noise state of the extra noise sources (20a, 20b, and 20c of FIG. 1) (E1). In such a situation, as soon as a call is received or as a communication button is input, the mobile terminal 100 enters a mode that controls a noise state of the extra noise sources (20a, 20b, and 20c of FIG. 1).

Further, referring to FIGS. 10B and 10C, when the mobile terminal 100 receives a user's voice instruction (e.g., quiet) (E2) or receives a specific sound signal (e.g., doorbell sound) (E3), the controller 180 of the mobile terminal 100 intercepts various noises generated by the extra noise sources (20a, 20b, and 20c of FIG. 1).

In FIG. 12, reference numeral 21 is an indicator representing a state in which the mobile terminal 100 enters a voice instruction input mode. When the indicator is activated, the mobile terminal 100 receives a predetermined voice instruction that can control a noise state of the extra noise sources (20a, 20b, and 20c of FIG. 1).

As the event is received, the controller 180 selects at least one of at least one extra noise source connected to the network (S120).

Thereafter, the controller 180 controls a noise state of the selected extra noise source (S130).

The network may include a DLNA network.

It is assumed that the at least one extra noise sources (e.g., 20a, 20b, and 20c of FIG. 1) are a TV 20a, a robot cleaner 20b, and a washing machine 20c.

The controller 180 of the mobile terminal 100 selects a target to transmit a control signal for removing or reducing noise of the extra noise sources (20a, 20b, and 20c of FIG. 1) by a predetermined reference.

The predetermined reference may be a noise state of each extra noise source. The noise state may be changed, for example, according to whether a source that causes noise is a sound signal or a vibration.

For example, when the source that causes noise is a sound signal, intensity (dB) of a sound signal may be a predetermined reference value. Further, when the source that causes noise is a vibration, the predetermined reference may be vibration intensity or a specific mode according to the vibration intensity.

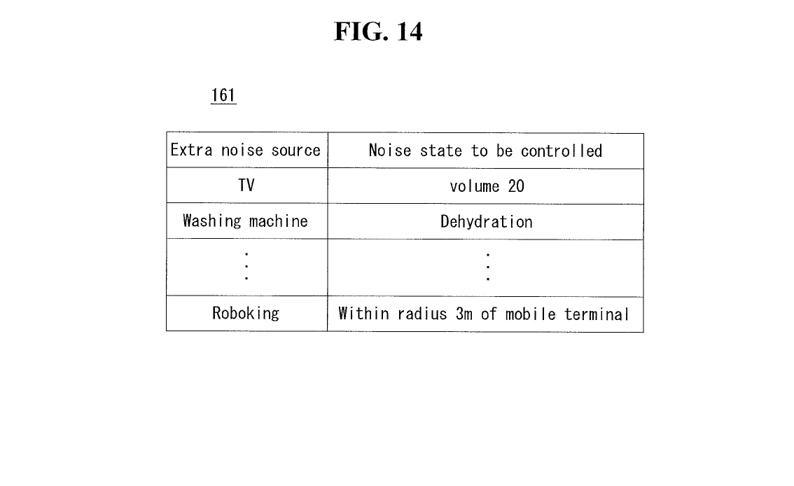

FIG. 14 is a table illustrating an example of a noise state to be controlled according to the kind of an extra noise source.

Referring to FIG. 14, the memory 160 of the mobile terminal 100 stores a list of a plurality of electronic devices (extra noise sources) connected to a network with the mobile terminal 100 as a database. Reference information in which noise of each electronic device is to be controlled is stored in the database.

For example, referring to FIGS. 1 and 11, in a case where the extra noise source is the TV 20a, when the mobile terminal 100 detects a predetermined event, if a volume of the TV 20a is, for example, “20”, the TV 20a may be a volume control target. Therefore, even if the mobile terminal 100 detects the event, when a volume of the TV 20a is “10”, the mobile terminal 100 may not adjust the volume. A reference value in which a volume of the TV 20a is to be controlled can be preset by a user.

As described above, an extra noise source may include a device that causes the noise by a vibration.

Referring to FIG. 14, when the extra noise source is the washing machine 20c, the washing machine 20c operates according to various operating modes such as a “ready mode, a wash mode, a rinse mode, a dehydration mode, and a dry mode”, and vibration intensity may be changed in each operating mode. Accordingly, a level of noise caused according to an operating mode may be also changed.

For example, in a case where the extra noise source is the washing machine 20c, when the mobile terminal 100 detects a predetermined event, if an operating mode of the washing machine 20c is a dehydration mode, the washing machine 20c may be a control target in which an operating mode is controlled. Therefore, even if the mobile terminal 100 detects the event, when an operating mode of the washing machine 20c is a “ready mode”, an operating mode of the washing machine 20c may not be controlled. A reference mode in which an operating mode of the washing machine 20c is to be controlled can be preset by a user.

Further, for example, the extra noise source may be the robot cleaner 20b. For example, the robot cleaner 20b may voluntarily move and generate predetermined noise by a vibration.

Therefore, a selection reference of the robot cleaner 20b may be a separation distance between the robot cleaner 20b and the mobile terminal 100. For example, when the mobile terminal 100 detects a predetermined event, if the robot cleaner 20b exists within a radius 3 m from the mobile terminal 100, the controller 180 may select the robot cleaner 20b as a control target device of a noise state. The reference distance from the mobile terminal 100 can be also previously set or changed by a user.

In the foregoing embodiments, when a predetermined event occurs in the mobile terminal 100, information related to a noise state (e.g., volume intensity, an operating mode (vibration intensity), and a distance from a mobile terminal) of each extra outside noise is transmitted to the mobile terminal 100.

Accordingly, the controller 180 of the mobile terminal 100 determines whether to control a noise state of each extra noise source by comparing noise state information received from the extra noise sources with a predetermined reference value (including reference sound intensity, reference vibration intensity, a reference separation distance, etc.) stored in the memory 160.

When a predetermined event occurs in the mobile terminal 100, the mobile terminal 100 may directly sense a noise state generating in the extra noise sources through various sensing means thereof. Thereafter, the mobile terminal 100 selects target devices to control a noise state based on the sensing result and the reference value stored in the memory 160.

The sensing means may include the microphone (122 of FIG. 6). The mobile terminal 100 may directly collect noise generated in the TV 20a, the robot cleaner 20b, and the washing machine 20c through the microphone 122.

The foregoing embodiments are examples of controlling noise of an extra noise source due to any one event generated in the mobile terminal 100. However, the present invention is not limited thereto.

The mobile terminal 100 may control a noise state of an extra noise source by a combination of a plurality of events. The plurality of events may be organically related events and may include an unrelated event.

For example, when the first event is reception of a call and the second event is a voice instruction, the controller 180 of the mobile terminal 100 may recognize a voice instruction event generated after the call receiving event as an event for controlling a noise state of the extra noise source. That is, when a call is received and a voice input mode is activated, if a voice instruction “Quiet” is input, the controller 180 weakly controls vibration intensity in order to reduce a volume of an extra noise source connected to a network, or reduce noise due to a vibration.

Further, when a first event is reception of a call and a second event is communication termination of a received call, the mobile terminal 100 can reduce a volume of the extra noise source (e.g., TV) to correspond to the first event and can recover a noise state of the extra noise source (TV) to a state before the first event to correspond to the second event generated after the first event.

By adjusting the extra sound source, the user can smoothly perform a function related to the event. For example, when the event is transmission and reception of a call, the user can perform communication without disturbance due to peripheral noise. Further, when doorbell sound is heard, by suppressing or intercepting noise of the extra noise source, the user can smoothly receive a visitor.

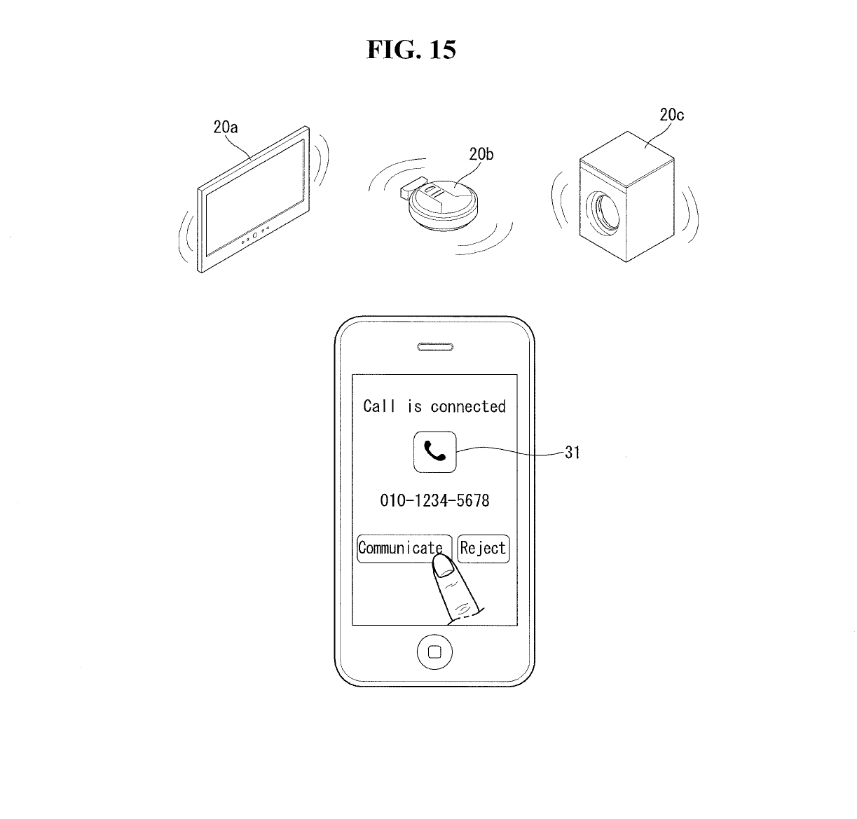

FIG. 15 is a diagram illustrating an example of automatically controlling a noise state of an extra noise source when an event occurs.

Referring to FIG. 15, the mobile terminal 100 forms a predetermined home network (e.g., DLNA) together with a plurality of electronic devices 20a, 20b, and 20c. The plurality of electronic devices 20a, 20b, and 20c each may be an extra noise source based on the mobile terminal 100.

When a call receiving event occurs in the mobile terminal 100 (31) and a user presses a communication button, the controller 180 of the mobile terminal 100 selects at least one extra noise source to control a noise state by a reference described at step S120 and controls a noise state of the selected extra noise source.

Therefore, in an embodiment described with reference to FIG. 15, when a predetermined event occurs in the mobile terminal 100, the controller 180 can automatically intercept or reduce noise of an extra noise source.

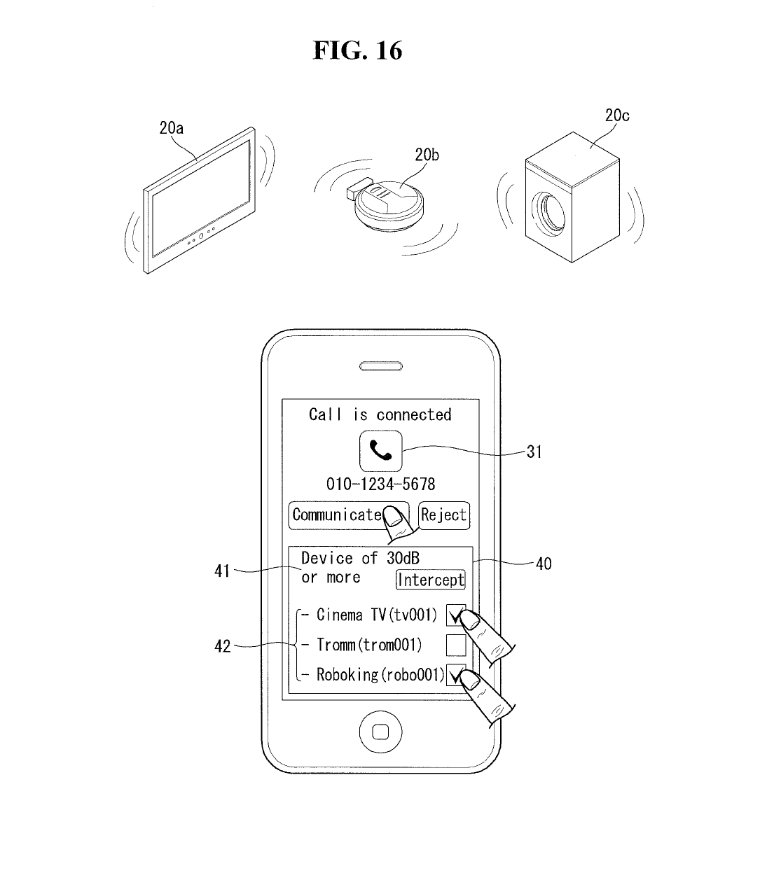

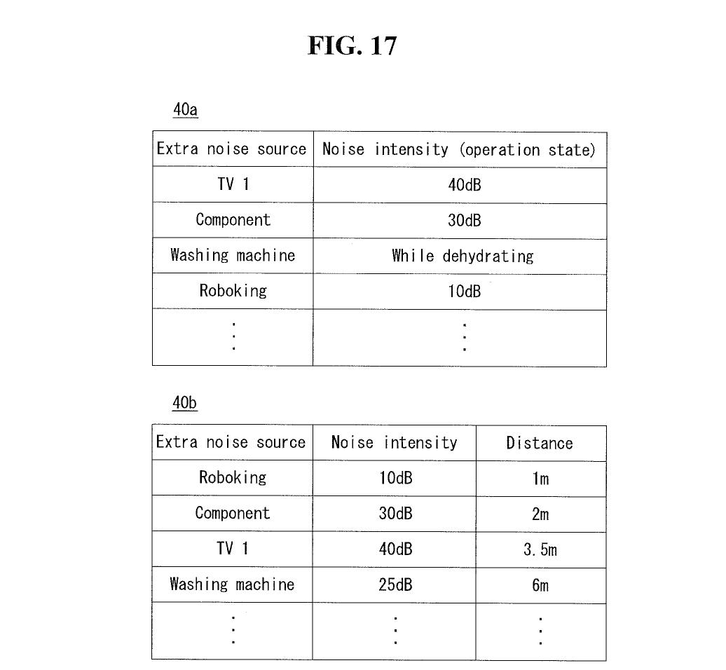

FIG. 16 is a diagram illustrating an example of manually selecting an extra noise source to be a control target, and FIG. 17 is a table illustrating an example of aligning and providing extra noise sources that can select according to a predetermined reference in order to select an extra noise source in an embodiment described with reference to FIG. 16.

Referring to FIG. 16, when a call receiving event occurs in the mobile terminal 100 (31), the controller 180 of the mobile terminal 100 provides a list 40 of a plurality of extra noise sources connected to the mobile terminal 100 with a network to the display 151.

The controller 180 provides a list of extra noise sources in which noise intensity of the extra noise sources is a predetermined value or more to the display 151.

When a control target device is selected from the provided list by a user, the controller 180 outputs and transfers a control signal for controlling a noise state of the selected device.

The controller 180 aligns and provides the extra noise sources on noise intensity basis (see 40a of FIG. 17). Accordingly, the user can more easily select a control target device of the provided list 40 based on noise intensity.

Further, the controller 180 controls to display noise intensity of the extra noise sources, but may aligns and provides the extra noise sources to the display 151 on a distance basis in which the extra noise source and the mobile terminal 100 are separated (see 40b of FIG. 17). Accordingly, the user can more easily select a control target device of the provided list 40 based on a distance.

The foregoing description describes embodiments of selecting an extra noise source to control a noise state to correspond to event occurrence when a predetermined event occurs in the mobile terminal.

Hereinafter, methods of controlling a noise state of the selected extra noise sources will be described in detail with reference to the drawings.

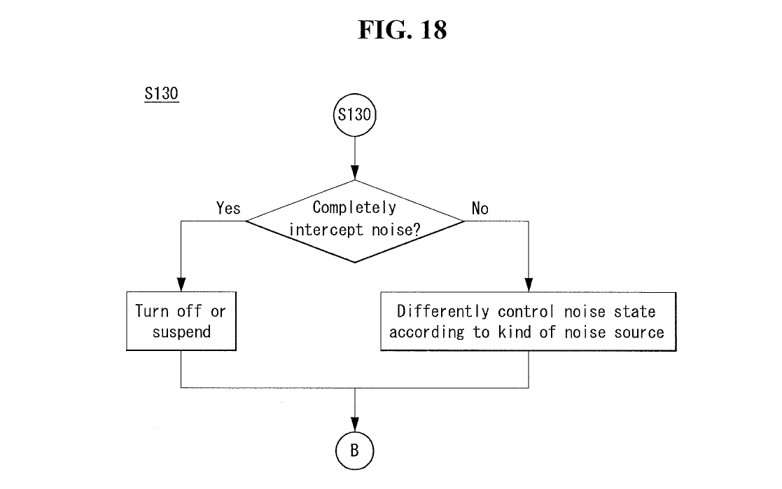

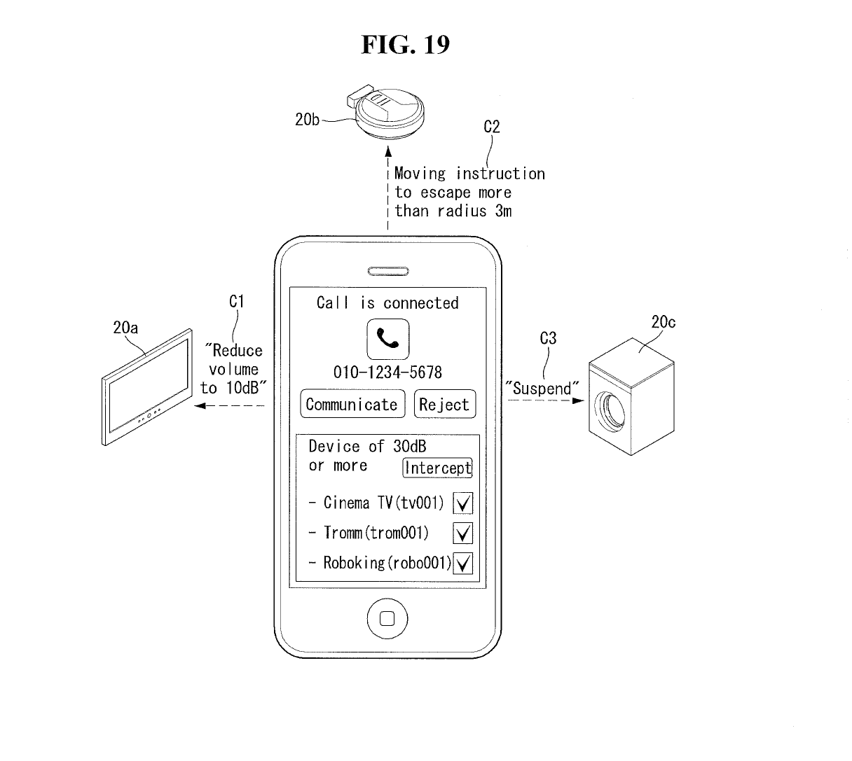

FIG. 18 is a flowchart illustrating a method of controlling a mobile terminal according to another embodiment of the present invention, and FIG. 19 is a diagram illustrating a method of controlling a mobile terminal according to an embodiment described with reference to FIG. 18.

Referring to FIG. 18, the controller 180 controls a noise state of the selected extra noise source (S130).

Specifically, the controller 180 selects to completely intercept noise of the selected extra noise source (S131).

The controller 180 of the mobile terminal 100 selects whether to completely intercept the noise or to reduce a noise level according to the kind of the selected extra noise source.

Therefore, if it is selected to completely intercept a noise state, the controller 180 generates a control signal to turn off power of the extra noise source or a control signal to suspend the extra noise source and transmits the control signal to a corresponding extra noise source (S132).

For example, when the extra noise source is the TV (20a of FIG. 1), the controller 180 may intercept noise by turning off power of the TV 20a, or intercept noise by suspending reproduction of presently reproducing multimedia contents.

Further, if it is selected to partially intercept the noise state instead of completely intercepting the noise state, the controller 180 differently controls a noise state according to the kind of the noise source (S133).

For example, when the extra noise source is the TV (20a of FIG. 1), the controller 180 may reduce a present volume to a predetermined reference value or less.

Further, for example, when the extra noise source is the washing machine (20c of FIG. 1), the controller 180 may control to convert a present operating mode of the washing machine from a dehydration mode to a rinse mode.

Referring to FIG. 19, the mobile terminal 100 detects a call receiving event and receives present noise state information from the extra noise sources 20a, 20b, and 20c. Alternatively, the mobile terminal 100 may detect a call receiving event and collect a noise state of each of the extra noise sources 20a, 20b, and 20c through the microphone 122.

Accordingly, the controller 180 selects devices in which a noise state should be controlled according to a predetermined reference. Alternatively, as a list of at least one extra noise source connected to the mobile terminal 100 with a network is provided to the display 151, and a user input for selecting at least one of the list is received, the controller 180 outputs a control signal for controlling a noise state of the selected at least one extra noise source.

The control signals each are transmitted to each device through the network.

For example, the controller 180 may transmit an instruction instructing to reduce a volume to 10 dB to the TV 20a, a moving instruction instructing to escape more than a radius 3 m from the mobile terminal 100 to the robot cleaner 20b, and a control instruction instructing to convert an operating mode to a suspension mode to the washing machine 20c. That is, the kind of a control signal may be also changed according to the kind of the extra noise source.

The foregoing description describes embodiments of controlling a noise state of peripheral extra noise sources before a call is connected after a call is received. However, the present invention is not limited thereto. For example, the present invention may include an example of controlling a noise state of an extra noise source in a state where a call is connected without a process of adjusting a noise state of an extra noise source.

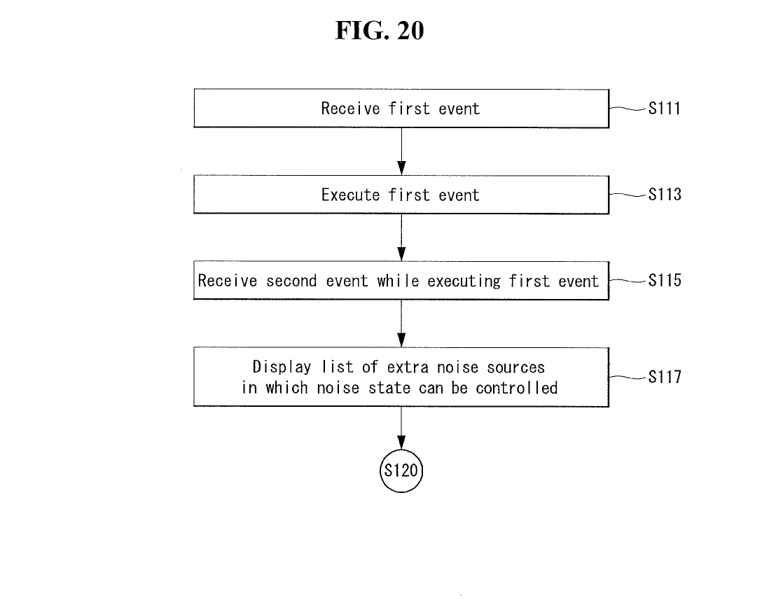

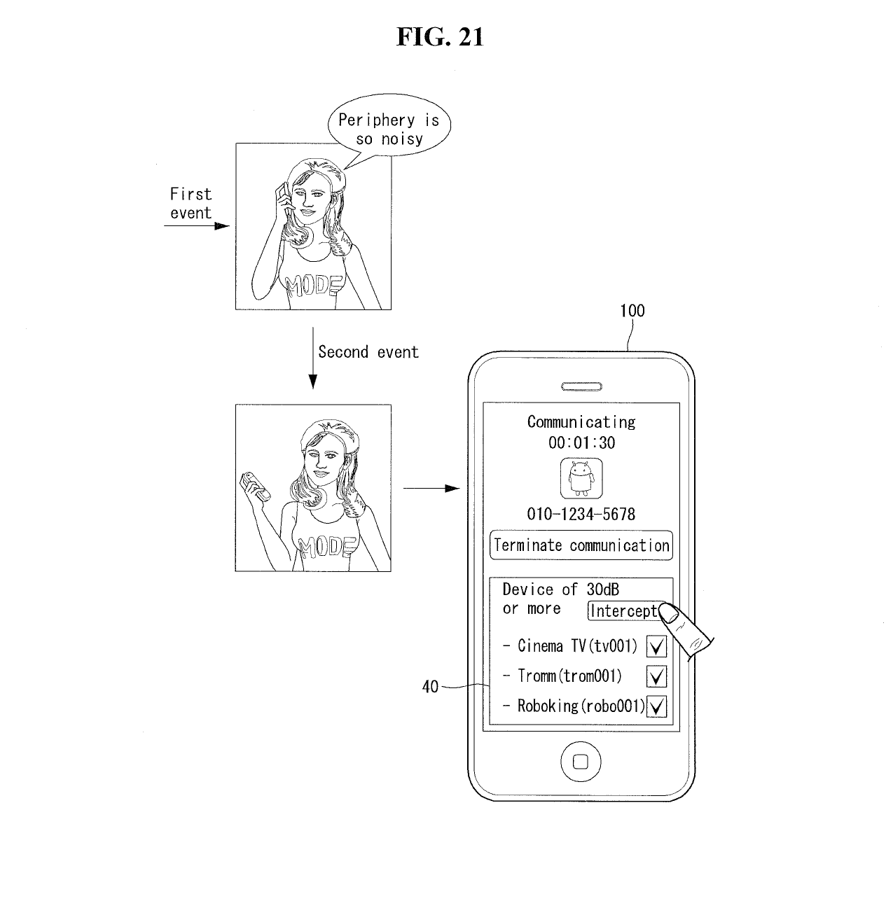

FIG. 20 is a flowchart illustrating a method of controlling a mobile terminal according to another embodiment of the present invention, and FIG. 21 is a diagram illustrating a method of controlling a mobile terminal according to an embodiment described with reference to FIG. 20.

The mobile terminal 100 receives a first event (S111). The first event may be reception of a call.

As the first event is received, the mobile terminal 100 executes the first event (S113). Execution of the first event may include connection of a call according to reception of the call.

While the first event is being executed, the mobile terminal 100 may receive a second event of the kind different from that of the first event (S115). The second event may be a task in which the proximity sensor (141 of FIG. 1) outputs a sensing result. That is, while a user performs communication according to the first event (call reception), when the user separates the mobile terminal 100 from the user's ear, the proximity sensor 141 of the mobile terminal 100 outputs a sensing result.

As the mobile terminal 100 receives the second event, the controller 180 controls to display a list of extra noise sources in which a noise state can be controlled in the display 151 of the mobile terminal 100 (S117).

Thereafter, as at least one of at least one extra noise source displayed in the list is selected by a user manipulation, the controller 180 controls a noise state of the selected extra noise source.

Referring to FIG. 20, as the first event (call reception) occurs, in the mobile terminal 100, a call is connected by a user manipulation. When a call is connected, if a sensing value of the proximity sensor 141 of the mobile terminal 100 is changed (i.e., as the user separates the mobile terminal 100 from the user's ear, a sensing value of the proximity sensor 141 is changed.), the mobile terminal 100 provides a user interface 40 that can select a control target device.

While the call is connected, the mobile terminal 100 may provide the user interface 40 (extra noise source list) that can select a control target device of at least one extra noise source.

The mobile terminal 100 receives the first event (S111). The controller 180 controls a first noise state of the extra noise source selected according to a predetermined reference (S112). Thereafter, the mobile terminal 100 executes the received first event (S113). The first noise state is a noise state before the mobile terminal 100 receives a noise state control signal.

For example, the received first event is call reception, and execution of the first event may include a task in which a call is connected by accepting the received call. The control of the first noise state may include reduction of noise of the extra noise source according to a control signal of the mobile terminal 100.

When the mobile terminal 100 receives a second event while executing the first event (S114), the controller 180 controls a second noise state (S115).

For example, the second event may be a task in which the proximity sensor (141 of FIG. 1) outputs a sensing result. That is, while the user performs communication according to the first event (call reception), when the user separates the mobile terminal 100 from the user's ear, the proximity sensor 141 of the mobile terminal 100 outputs the sensing result.

The control of the second noise state may include control of reducing noise intensity of the selected extra noise source by selecting at least one extra noise source of the list 40 when the list 40 of peripheral extra noise sources is provided to the user through the display unit 151 of the mobile terminal. In FIG. 21, when a TV, a washing machine, and a cleaner are selected from the list 40 of extra noise sources provided through the display unit 151 of the mobile terminal 100, the controller 180 controls a noise state of the selected devices to a noise state previously set to each device.

For example, in the TV, it may be controlled to adjust volume intensity to a preset volume or less. Further, in the washing machine, a present mode of the washing machine may be adjusted to a preset washing mode (e.g., a suspension mode). Further, in the cleaner, an advancing direction of a robot cleaner may be controlled to recede from the user.

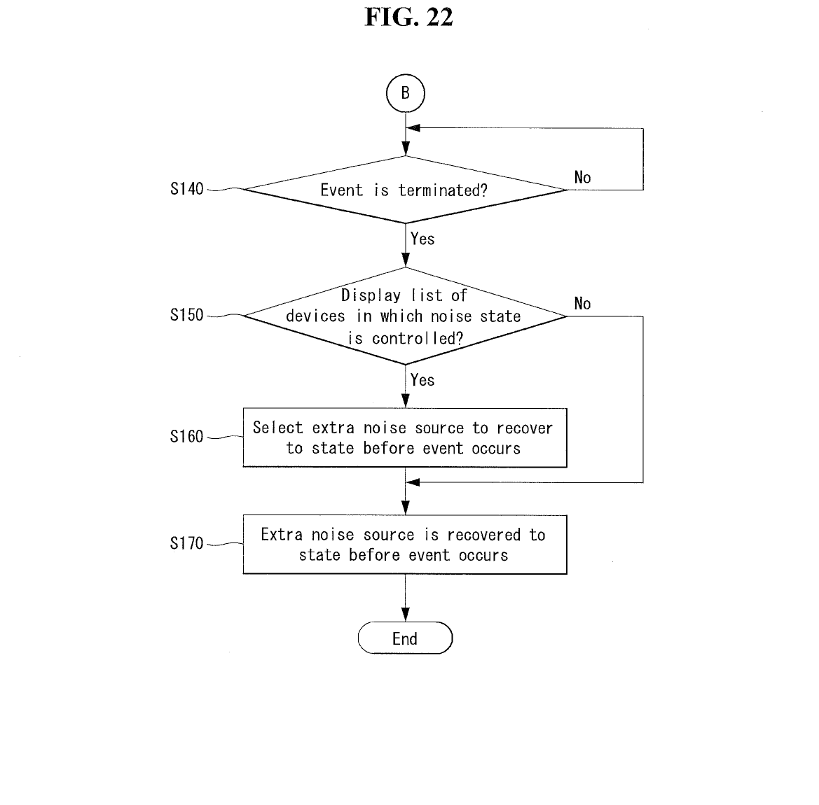

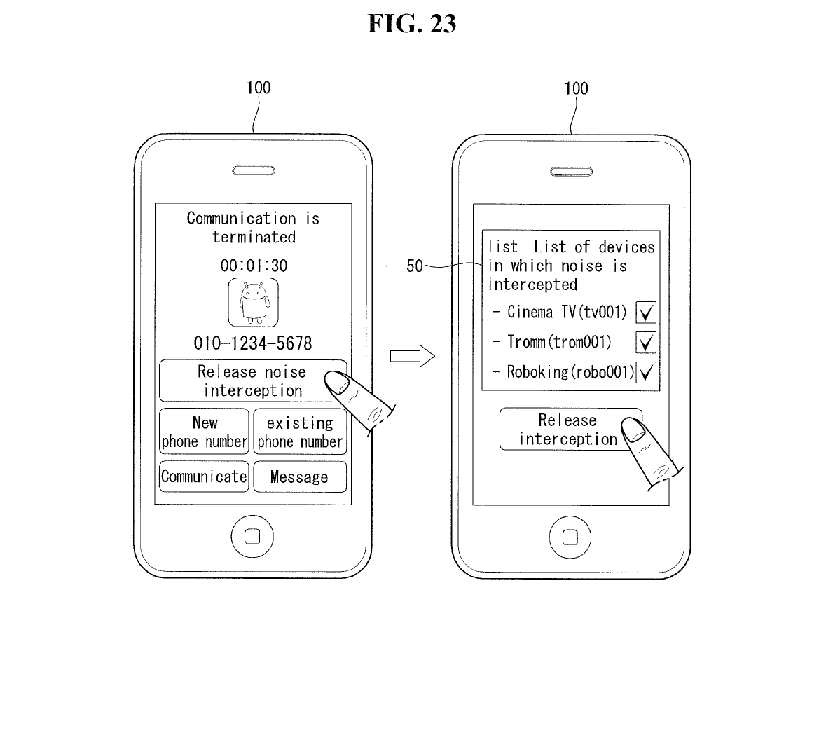

FIG. 22 is a flowchart illustrating a method of controlling a mobile terminal according to another embodiment of the present invention, and FIG. 23 is a diagram illustrating a method of controlling a mobile terminal according to an embodiment described with reference to FIG. 22.

Referring to FIGS. 19 and 20, after a predetermined event occurs in the mobile terminal 100 and a noise state of an extra noise source is controlled to correspond to the event, when the event is terminated, operation of the mobile terminal will be described.

First, the controller 180 determines whether the event is terminated (S140), and if the event is terminated, the controller 180 determines whether to provide a list of devices in which a noise state is controlled to the display 151 (S150).

If a list of devices in which a noise state is controlled is provided to the display 151, an extra noise source to recover to a state before the event occurs is selected by a user manipulation (S160), and a noise state of the selected extra noise source is recovered to a state before the event occurs (S170).

If a list of devices in which a noise state is controlled is not provided to the display 151 at step S150, after the event is terminated, the controller 180 does not separately provide a list that can select an outside device to recover a noise state to an original state but recovers a noise state of all devices in which a noise state is controlled to an original state.

The method for controlling of the electronic device according to embodiments of the present invention may be recorded in a computer-readable recording medium as a program to be executed in the computer and provided. Further, the method for controlling a display device and the method for displaying an image of a display device according to embodiments of the present invention may be executed by software. When executed by software, the elements of the embodiments of the present invention are code segments executing a required operation. The program or the code segments may be stored in a processor-readable medium or may be transmitted by a data signal coupled with a carrier in a transmission medium or a communication network.

The computer-readable recording medium includes any kind of recording device storing data that can be read by a computer system. The computer-readable recording device includes a ROM, a RAM, a CD-ROM, a DVD±ROM, a DVD-RAM, a magnetic tape, a floppy disk, a hard disk, an optical data storage device, and the like. Also, codes which are distributed in computer devices connected by a network and can be read by a computer in a distributed manner are stored and executed in the computer-readable recording medium.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A mobile terminal comprising:
a communication unit configured to communicate, over a network, with at least one noise source that generates audible noise and that is separate from the mobile terminal;
a display unit;
a database configured to store reference noise values for controlling noise sources according to types of the noise sources; and
a controller configured to:
detect a predetermined event;
access noise state information of the at least one noise source, the noise state information comprising at least one of a sound intensity, a vibration intensity, and a distance between the mobile terminal and the at least one noise source;
based on detection of the predetermined event, display, on the display unit, a list comprising the at least one noise source and the accessed noise state information corresponding to the at least one noise source;
receive input selecting one or more noise sources in the list; and
transmit a signal for controlling a noise state of the one or more selected noise sources based on the received input.

2. The mobile terminal of claim 1, wherein the controller is configured to detect the predetermined event by detecting at least one of transmission and reception of a call at the mobile terminal.

3. The mobile terminal of claim 1, wherein the controller is configured to detect the predetermined event by detecting reception of a user's voice instruction.

4. The mobile terminal of claim 1, wherein the controller is configured to detect the predetermined event by detecting reception of a specific sound signal.

5. The mobile terminal of claim 1, further comprising a microphone,
wherein the controller is configured to access the noise state information of the at least one noise source by determining a noise intensity of the noise source based on noise inputted by the microphone.

6-8. (canceled)

9. The mobile terminal of claim 1, wherein the controller is configured to transmit the signal for controlling the noise state of the one or more selected noise sources by transmitting a signal to turn off power of at least one of the one or more selected noise sources.

10. The mobile terminal of claim 1, wherein the controller is configured to suspend power of the one or more selected noise sources while the predetermined event is being executed, determine that execution of the predetermined event has completed, and restore power to the one or more selected noise sources based on the determination that execution of the predetermined event has completed.

11. The mobile terminal of claim 1, wherein the controller is configured to:
determine a type of the predetermined event;
determine a manner of controlling the noise state of the one or more selected noise sources based on the type of the predetermined event, the manner of controlling the noise state being different for a first type of event as compared to a second type of event; and
control the noise state of the one or more selected noise sources in the determined manner of controlling the noise state.

12. The mobile terminal of claim 1, wherein the controller is configured to:
monitor the predetermined event;
detect termination of the predetermined event based on the monitoring; and
based on the detected termination of the predetermined event, recover the noise state of the one or more selected noise sources to a state prior to transmitting the signal.

13. The mobile terminal of claim 1, wherein the communication unit is configured to communicate with the at least one noise source through a digital living network alliance (DLNA) network.

14. A method of controlling a mobile terminal, the method comprising:
detecting a predetermined event;
accessing noise state information of the at least one noise source, the noise state information comprising at least one of a sound intensity, a vibration intensity, and a distance between the mobile terminal and the at least one noise source;
based on detection of the predetermined event, displaying, on a display unit, a list comprising the at least one noise source and the accessed noise state information corresponding to the at least one noise source;
receiving input selecting one or more noise sources in the list; and
transmitting a signal for controlling a noise state of the one or more selected noise sources based on the received input.

15. The method of claim 14, wherein accessing noise state information of the at least one noise source comprises determining a noise intensity of the noise source based on noise inputted by a microphone.

16. (canceled)

17. The method of claim 14, detecting the predetermined event comprises detecting at least one of transmission of a call, reception of a call, reception of a user's voice instruction, and reception of a specific sound signal.

18. The method of claim 14, further comprising:
monitoring the predetermined event;
detecting termination of the predetermined event based on the monitoring; and
based on the detected termination of the predetermined event, recovering the noise state of the one or more selected noise sources to a state prior to transmitting the signal.

19. A system comprising:
a mobile terminal; and
at least one noise source that generates audible noise, that is separate from the mobile terminal, and that communicates with the mobile terminal through a network,
wherein the mobile terminal includes a controller configured to:
detect a predetermined event;
access noise state information of the at least one noise source, the noise state information comprising at least one of a sound intensity, a vibration intensity, and a distance between the mobile terminal and the at least one noise source;
based on detection of the predetermined event, display, on a display unit, a list comprising the at least one noise source and the accessed noise state information corresponding to the at least one noise source;
receive input selecting one or more noise sources in the list; and
transmit a signal for controlling a noise state of the one or more selected noise sources based on the received input.

20. The system of claim 19, wherein the at least one noise source and the mobile terminal communicate through a digital living network alliance (DLNA) network.

21. The mobile terminal of claim 1, wherein the controller is configured to access the noise state information of the at least one noise source by receiving, from the at least one noise source through the communication unit, noise state information of the at least one noise source.

22. The mobile terminal of claim 1:
wherein the at least one noise source comprises multiple noise sources that each generate audible noise and that each is separate from the mobile terminal;
wherein the controller is configured to access noise state information of the at least one noise source by accessing noise state information of each of the multiple noise sources; and
wherein the controller is configured to display the list comprising the at least one noise source and the accessed noise state information corresponding to the at least one noise source by:
determining types of the multiple noise sources;
accessing, from the database, stored reference noise values corresponding to the determined types of the multiple noise sources;
comparing the accessed reference noise values to the accessed noise state information;
based on comparison results, identifying a subset of the multiple noise sources that have noise state information meeting the accessed reference noise values; and
displaying a list comprising the subset of the multiple noise sources and the accessed noise state information corresponding to the subset of the multiple noise sources.

23. The mobile terminal of claim 1:
wherein the at least one noise source comprises a first noise source that generates audible noise and that is separate from the mobile terminal, a second noise source that generates audible noise and that is separate from the mobile terminal, and a third noise source that generates audible noise and that is separate from the mobile terminal;
wherein the controller is configured to access noise state information of the at least one noise source by accessing a sound intensity of the first noise source, a vibration intensity of the second noise source, and a distance between the mobile terminal and the third noise source for the third noise source; and
wherein the controller is configured to display the list comprising the at least one noise source and the accessed noise state information corresponding to the at least one noise source by displaying a list comprising the first noise source and the sound intensity of the first noise source, the second noise source and the vibration intensity of the second noise source, and the third noise source and the distance between the mobile terminal and the third noise source for the third noise source.

24. The mobile terminal of claim 1, wherein the controller is configured to receive input selecting one or more noise sources in the list by receiving touch input selecting one or more noise sources in the list.
